(19) United States
(12) Patent Application Publication
(10) Pub. No.: US 2026/0279403 A1
(43) Pub. Date: Sep. 17, 2026

(54) SYSTEM AND METHOD FOR GENERATING SUBTITLES AND VOICE DUBBING TO WHICH ARTIFICIAL INTELLIGENCE-BASED VOICE TECHNOLOGY IS APPLIED

(71) Applicant: AUNIONAI CO. LTD., Gwangju (KR)

(72) Inventor: Hong Kook KIM, Gwangju (KR)

(73) Assignee: AUNIONAI CO. LTD., Gwangju (KR)

(21) Appl. No.: 19/679,957

(22) Filed: May 18, 2026

Related U.S. Application Data
(63) Continuation of application No. PCT/KR2024/017829, filed on Nov. 12, 2024.

(30) Foreign Application Priority Data
Nov. 22, 2023 (KR) 10-2023-0163212

(51) Int. Cl. G11B 27/036; G06F 40/58; G10L 13/04; G10L 15/30; G10L 21/028

(52) U.S. Cl. CPC G11B 27/036; G06F 40/58; G10L 13/04; G10L 15/30; G10L 21/028

(57) ABSTRACT

Provided is a system for generating subtitles and voice dubbing to which an artificial intelligence-based voice technology is applied. The system includes a server and a terminal. The server includes a communication unit that receives image information or voice information from the terminal and a processor that separates a voice signal and background sound information from voice information included in the image information or the received voice information, converts the separated voice signal into text, translates the converted text into a target language, generates a voice signal composed in the target language based on at least one of the voice signal, the converted text, and the translated result, and mixes the generated voice signal with the separated background sound information.

### CROSS-REFERENCE TO RELATED APPLICATIONS

The present application is a continuation of International Patent Application No. PCT/KR2024/017829, filed on Nov. 12, 2024, which is based upon and claims the benefit of priority to Korean Patent Application No. 10-2023-0163212 filed on Nov. 22, 2023. The disclosures of the above-listed applications are hereby incorporated by reference herein in their entirety.

### BACKGROUND

Embodiments of the present disclosure described herein relate to a system and a method for generating subtitles and voice dubbing to which an artificial intelligence-based voice technology is applied.

Recently, a video streaming market associated with a media content market has grown at a fast speed. Furthermore, as the video streaming market has expanded into the global market rather than the domestic market, there has been an increase in needs for a technology for generating subtitles and voice dubbing.

In detail, in the media content market gradually increasing, a one-man creator provides a high-quality video by generating subtitles and voice dubbing to raise his/her competitiveness. Thus, a service market for generating subtitles and voice dubbing has expanded.

Because the current generation of subtitles and voice dubbing is manually performed, it may take a long time to produce and the ability to convey meaning through subtitles and voice dubbing may vary depending on the producer's linguistic and cultural understanding. Furthermore, due to mistranslation or like in the translation process, the dialog from the original work may be delivered differently from the original intention.

Furthermore, for dubbing generation, it is difficult to convey the language and emotions of native speakers. There is a problem in which the image itself may become unnatural as music, a background sound, a sound effect, or the like of original content according to the dubbing generation is lost.

Thus, there are needs for a technology capable of generating subtitles and voice dubbing, which reflect the linguistic and cultural differences of the country where the original work was produced and are not unnatural although inserted into the image.

### SUMMARY

Embodiments of the present disclosure provide a system and a method for generating natural subtitles and voice dubbing via artificial intelligence.

According to an embodiment, a system for generating subtitles and voice dubbing may include a server and a terminal. The server may include a communication unit that receives image information or voice information from the terminal and a processor that separates a voice signal and background sound information from voice information included in the image information or the received voice information, converts the separated voice signal into text, translates the converted text into a target language, generates a voice signal composed in the target language based on at least one of the voice signal, the converted text, and the translated result, and mixes the generated voice signal with the separated background sound information.

In an embodiment, the processor may generate subtitles on the image information, using the translated result, and may mix the generated voice signal with the separated background sound information, using the result of generating the subtitles.

In an embodiment, the processor may mix the generated voice signal with the separated background sound information, using time information in which the subtitles are output on the image information.

In an embodiment, the processor may mix the generated voice signal with the separated background sound information, using the result of separating the voice signal and the background sound information from the voice information.

In an embodiment, the processor may mix the generated voice signal with the separated background sound information, using time information in which the voice signal is separated from the voice information.

According to an embodiment, a method for generating subtitles and voice dubbing in a system including a server and a terminal may include receiving, by the server, image information or voice information, separating, by the server, a voice signal and background sound information from voice information included in the image information or the received voice information, converting, by the server, the separated voice signal into text, translating, by the server, the converted text into a target language, generating, by the server, a voice signal composed in the target language based on at least one of the voice signal, the converted text, and the translated result, and mixing, by the server, the generated voice signal with the separated background sound information.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a drawing of the overall system of the present disclosure.

FIG. 2 is a block diagram of a server included in a system for generating subtitles and voice dubbing in the present disclosure.

FIG. 3 is a block diagram of a terminal included in a system for generating subtitles and voice dubbing in the present disclosure.

FIG. 4 is a block diagram of a processor included in a system for generating subtitles and voice dubbing in the present disclosure.

FIGS. 5 and 6 are flowcharts of a method for generating subtitles and voice dubbing according to the present disclosure.

FIG. 7 is a flowchart of a method for generating voice dubbing using the International Phonetic Alphabet according to the present disclosure.

FIG. 8 is a conceptual diagram illustrating an embodiment of converting a voice signal into text composed in the International Phonetic Alphabet in a system for generating voice dubbing according to the present disclosure.

FIG. 9 is a conceptual diagram illustrating an artificial intelligence model included in a system for generating voice dubbing according to the present disclosure.

### DETAILED DESCRIPTION

The same reference numerals denote the same components throughout the present disclosure. The present disclosure does not describe all components of the embodiments, and general contents or duplicated contents between the embodiments in the technical field to which the present disclosure pertains will be omitted. Terms such as “unit, module, member, or block” used in the specification may be implemented as software or hardware, and according to the embodiments, a plurality of “units, modules, members, or blocks” may be implemented as one component or as one “unit, module, member, or block” may include a plurality of components.

Throughout the specification, when a first part is “connected” with a second part, this includes not only a case in which the first part is directly connected with the second part but also a case in which the first part is indirectly connected with the second element with the other part interposed therebetween. The indirect connection includes being connected over a wireless communication network.

Furthermore, when a certain part “includes” a certain component, it means that other components may be further included rather than excluding other components unless specifically stated to the contrary.

Throughout the specification, when a first member is located “on” a second member, this includes not only a case where the first member is in contact with the second member, but also a case where there is a third member between the two members.

The terms “first” and “second” is used to distinguish one component from another component and the components are not limited by the above-mentioned terms.

Singular expressions include plural expressions unless the context clearly indicates an exception.

In each step, the identification code is used for convenience of description, and the identification code does not describe the order of each step. Each of the steps may be performed out of the stated order unless the context clearly dictates the specific order.

A description will be given of an action principle and embodiments of the present disclosure with reference to the accompanying drawings.

In the specification, the “system according to the present disclosure” includes all of various devices capable of performing arithmetic processing to provide a user with results. For example, the system according to the present disclosure may include all of a computer, a server device, and a portable terminal or may be in any one form.

Herein, the computer may include, for example, a notebook loaded with a web browser, a desktop, a laptop, a tablet PC, a slate PC, or the like.

The server device may be a server for performing communication with an external device to process information, which may include an application server, a computing server, a database server, a file server, a game server, a mail server, a proxy server, a web server, and the like.

The portable terminal may be, for example, a wireless communication device for ensuring portability and mobility, which may include all types of handheld-based wireless communication devices, such as a personal communication system (PCS), a global system for mobile communications (GSM), personal digital cellular (PDC), a personal handyphone system (PHS), a personal digital assistant (PDA), international mobile telecommunication (IMT)-2000, code division multiple access (CDMA)-2000, W-code division multiple access (W-CDMA), a wireless broadband Internet (WiBro) terminal, and a smart phone, and a wearable device, such as a watch, a ring, a bracelet, an anklet, a necklace, glasses, contact lenses, or a head-mounted-device (HMD).

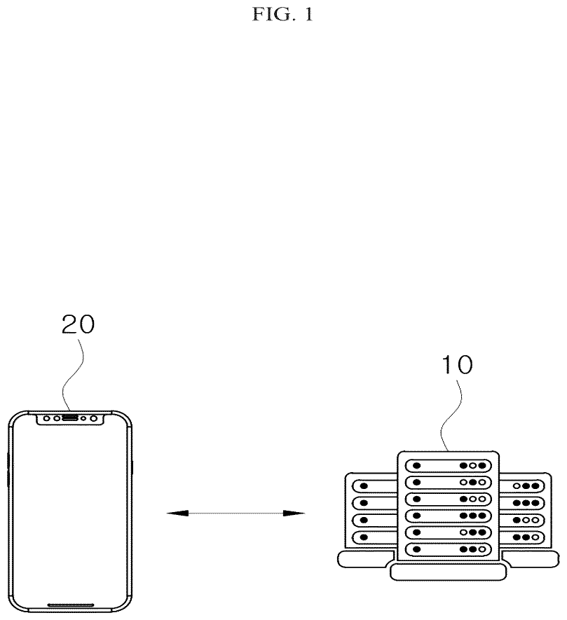

Hereinafter, a description will be given of a system for generating subtitles and voice dubbing according to the present disclosure. FIG. 1 is a drawing of the overall system of the present disclosure.

Referring to FIG. 1, the system for generating the subtitles and the voice dubbing according to the present disclosure may include at least one of a server 10 and a terminal 20. In detail, the system for generating the subtitles and the voice dubbing according to the present disclosure may be implemented alone by the server 10 or the terminal 20 or may be implemented in the form of a system including at least one of the server 10 and the terminal 20. A description about the system for generating the subtitles and the voice dubbing, which will be described below, may be applied to the case in which the system for generating the subtitles and the voice dubbing according to the present disclosure is implemented alone by the server 10 or the terminal 20 or is implemented in the form of the system including the at least one of the server 10 and the terminal 20.

The server 10 may be connected with the at least one terminal 20 over a network to transmit information to each of a plurality of terminals and generate data necessary for subtitles and voice dubbing generation learning based on information received from at least one of at least one terminal 20.

Meanwhile, it is obvious to those skilled in the art that the terminal 20 is not limited to the above-mentioned portable terminal and may include a notebook loaded with a processor, a desktop, a laptop, a tablet PC, a slate PC, or the like.

Hereinafter, a description will be given of each of the server 10 and the terminal 20 for implementing the system for generating the subtitles and the voice dubbing according to the present disclosure.

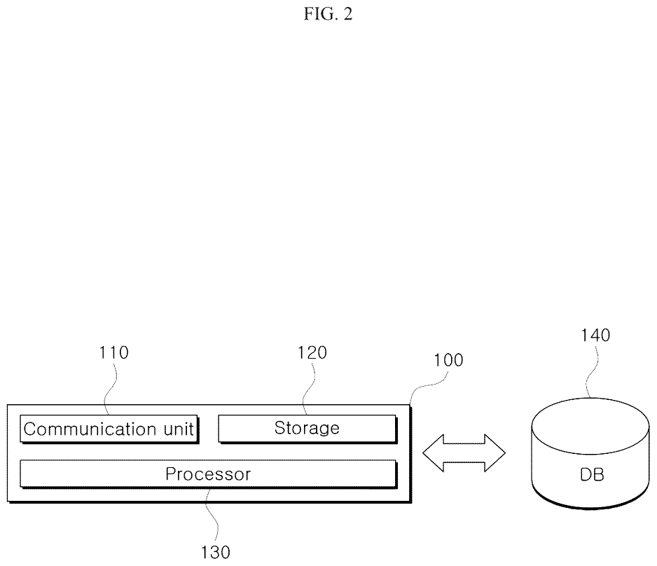

FIG. 2 is a block diagram of a server included in a system for generating subtitles and voice dubbing in the present disclosure.

A server 100 according to the present disclosure may include at least one of a communication unit 110, storage 120, and a processor 130.

The communication unit 110 may perform communication with at least one of a terminal, external storage (e.g., a database (DB) 140), an external server, and a cloud server.

Meanwhile, in the external server or the cloud server, the communication unit 110 may be configured to play a role as at least a part of the processor 130. In other words, it is possible for the external server or the cloud server to perform data processing, data computation, or the like. The present disclosure does not impose a special restriction on such a scheme.

Meanwhile, the communication unit 110 may support various communication schemes depending on a communication specification of a target (e.g., an electronic device, an external server, a device, or the like) to communicate.

For example, the communication unit 110 may be implemented to communicate with the communication target, using at least one of wireless LAN (WLAN), wireless-fidelity (Wi-Fi), Wi-Fi Direct, digital living network alliance (DLNA), wireless broadband (WiBro), world interoperability for microwave access (WiMAX), high speed downlink packet access (HSDPA), high speed uplink packet access (HSUPA), long term evolution (LTE), LTE-Advanced (LTE-A), 5th generation mobile telecommunication (5G), Bluetooth™, radio frequency identification (RFID), infrared data association (IrDA), ultra-wideband (UWB), ZigBee, near field communication (NFC), and wireless universal serial bus (USB) technologies.

Next, the storage 120 may be configured to store various pieces of information associated with the present disclosure. In the present disclosure, the storage 120 may be provided in the device itself according to the present disclosure. In contrast, at least a part of the storage 120 may refer to at least one of the database (DB) 140 and cloud storage (or a cloud server). In other words, it may be understood that it is sufficient that the storage 120 is a space which stores information necessary for the apparatus and the method according to the present disclosure and the storage 120 does not have a restriction on a physical space. Thus, hereinafter, the storage 120, the database (DB) 140, the external storage, the cloud storage (or the cloud server) are not separately divided and all are represented as the storage 120.

Next, the processor 130 may be configured to control the overall operation of the device associated with the present disclosure. The processor 130 may process a signal, data, information, or the like input or output via the components described above or may provide or process appropriate information or an appropriate function to a user.

The processor 130 may include at least one central processing unit (CPU) to perform the function according to the present disclosure.

At least one component may be added or deleted in response to performance of the components illustrated in FIG. 2. Furthermore, those skilled in the art will easily understand that mutual positions of the components are able to change in response to the performance or structure of the device.

Hereinafter, a description will be given in detail of the terminal included in the system for generating the subtitles and the audio dubbing in the present disclosure.

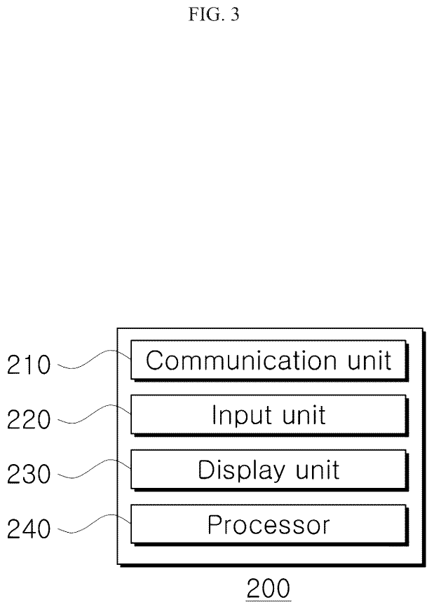

FIG. 3 is a block diagram of a terminal included in a system for generating subtitles and voice dubbing in the present disclosure.

Referring to FIG. 3, a terminal 200 according to the present disclosure may include a communication unit 210, an input unit 220, a display unit 230, a processor 240, and the like. Because the components illustrated in FIG. 3 are not essential in implementing the system for generating the subtitles and the voice dubbing according to the present disclosure, the terminal described in the specification may have components which are greater than or less than the components listed above.

The communication unit 210 among the components may include one or more components for facilitating communication with an external device and may include at least one of, for example, a broadcasting reception module, a wired communication module, a wireless communication module, a short-range communication module, or a location information module.

The wired communication module may include various cable communication modules, such as a universal serial bus (USB), a high definition multimedia interface (HDMI), a digital visual interface (DVI), recommended standard 1302(RS-1302 ), power line communication, or a plain old telephone service (POTS), as well as various wired communication modules, such as a local area network (LAN) module, a wide area network (WAN) module, or a value added network (VAN) module.

The wireless communication module may include a wireless communication module which supports various wireless communication schemes, such as a global system for mobile communication (GSM), code division multiple access (CDMA), wideband CDMA (WCDMA), a universal mobile telecommunication system (UMTS), time division multiple access (TDMA), long term evolution (LTE), 4th generation (4G), 5th generation (5G), or 6th generation (6G), other than a wireless-fidelity (Wi-Fi) module and a wireless broadband (WiBro) module.

The input unit 220 may be to input image information (or an image signal), audio information (or an audio signal), data, or information input from a user, which may include at least one of at least one camera, at least one microphone, and a user input unit. Voice data or image data collected by the input unit 220 may be analyzed and then processed as a control command of the user.

The display unit 230 may be to generate an output associated with a visual, auditory, or tactile sense, which may include at least one of a display, a sound output unit, a haptic module, and an optical output unit. The display may form a mutual layer structure with a touch sensor or may be integrally formed with the touch sensor to implement a touch screen. Such a touch screen may function as a user input unit for providing an input interface between the present device and a user and may simultaneously provide an output interface between the present device and the user.

The display may display (output) information processed by the present device. For example, the display may display execution screen information of an application program (e.g., an application) run by the present device or user interface (UI) or graphic user interface (GUI) information according to such execution screen information.

Other than the above-mentioned components, the above-mentioned terminal 200 may further include an interface unit and a memory.

The interface unit may play a role as a path with various types of external devices connected with the present device. Such an interface unit may include at least one of a wired/wireless headset port, an external charger port, a wired/wireless data port, a memory card port, a port for connecting a device including a subscriber identity module (SIM), an audio input/output (I/O) port, a video I/O port, and an earphone port. In the present device, appropriate control associated with the external device connected with the interface unit may be performed.

The memory may store data supporting various functions of the present device and a program for an operation of the processor, may store pieces of input/output data (e.g., a music file, a still image, a moving image, and the like), and may store various application programs or applications run by the present device, pieces of data for an operation of the present device, or instructions. At least some of such application programs may be downloaded from an external server through wireless communication.

The memory may include at least one type of storage medium among a flash memory type memory, a hard disk type memory, a solid state disk (SSD) type memory, a silicon disk drive (SDD) type memory, a multimedia card micro type memory, a card type memory (e.g., a secure digital (SD) memory, an extreme digital (XD) memory or the like), a random access memory (RAM), a static RAM (SRAM), a read-only memory (ROM), an electrically erasable programmable ROM (EEPROM), a programmable ROM (RPOM), a magnetic memory, a magnetic disc, and an optical disc. Furthermore, the memory may be separated from the present device, but may be a database connected wired or wirelessly.

Meanwhile, the above-mentioned terminal 200 may include the processor 240. The processor 240 may be implemented with a memory storing an algorithm for controlling operations of the components in the present device or data for a program for representing the algorithm and at least one processor (not shown) for performing the above-mentioned operation using the data stored in the memory. At this time, the memory and the processor may be implemented as separate chips, respectively. Alternatively, the memory and the processor may be implemented as a single chip.

Meanwhile, the processor may control any one or some of the above-mentioned components in combination to implement various embodiments according to the present disclosure, which will be described below, on the present device.

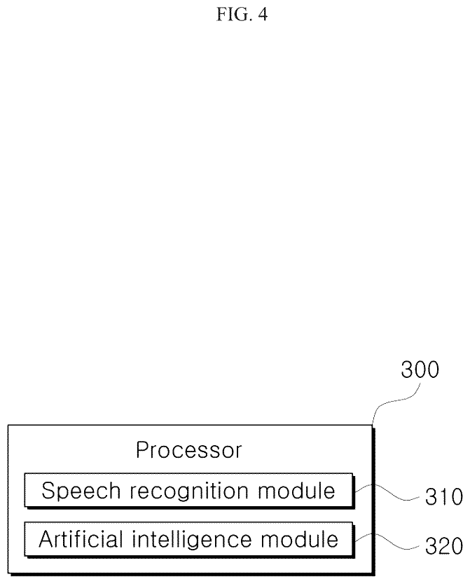

Meanwhile, at least one component may be added or deleted in response to performance of the components illustrated in FIGS. 1 to 3. Furthermore, those skilled in the art will easily understand that mutual positions of the components are able to change in response to the performance or structure of the device. FIG. 4 is a block diagram of a processor included in a system for generating subtitles and voice dubbing in the present disclosure.

Meanwhile, as in FIG. 4, a processor included in at least one of a server and a terminal may include a plurality of modules for implementing a system for generating subtitles and voice dubbing, which will be described below. In detail, a processor 300 may include a speech recognition module 310 and an artificial intelligence module 320. It is described that a method for generating subtitles and voice dubbing, which will be described below, is implemented by operations of the modules and an operation of each step, which will be described below, is not necessarily performed by the modules.

Hereinafter, a description will be given of artificial intelligence described in the present disclosure.

A function associated with the artificial intelligence according to the present disclosure may operate via a processor and a memory loaded into the server and the terminal, which are described above. The processor may be composed of one processor or a plurality of processors. At this time, the one processor or the plurality of processors may be a universal processor, such as a central processing unit (CPU), an application processor (AP), or a digital signal processor (DSP), a dedicated graphics processor, such as a graphics processing unit (GPU) or a vision processing unit (VPU), or a dedicated artificial intelligence processor, such as a neural processing unit (NPU). The one processor or the plurality of processors may control to process input data, depending on a predefined operation rule or an artificial intelligence model stored in the memory. Alternatively, when the one processor or the plurality of processors are the dedicated artificial intelligence processor or the dedicated artificial intelligence processors, the dedicated artificial intelligence processor may be designed in a hardware structure specialized for processing a specific artificial intelligence model.

A predefined operation rule or an artificial intelligence model are characterized by being created through learning. Herein, being created through the learning means that the predefined operation rule or the artificial intelligence model set to perform a desired characteristic (or purpose) is made as a basic artificial intelligence model is trained using a plurality of pieces of training data by a learning algorithm. Such learning may be performed in the device itself in which the artificial intelligence according to the present disclosure is performed and may be performed via a separate server and system. An example of the learning algorithm may be supervised learning, unsupervised learning, semi-supervised learning, or reinforcement learning, but not limited to the above-mentioned example.

The artificial intelligence model may be composed of a plurality of neural network layers. Each of the plurality of neural network layers may have a plurality of weight values and may perform neural network operation via operation between the result of operation of a previous layer and the plurality of weight values. The plurality of weight values of the plurality of neural network layers may be optimized by the result of training the artificial intelligence model. For example, the plurality of weight values may be updated such that a loss value or a cost value obtained by the artificial intelligence model during the training process is reduced or minimized. The artificial neural network may include a deep neural network (DNN) and may include, for example, a convolutional neural network (CNN), a deep neural network (DNN), a recurrent neural network (RNN), a restricted Boltzmann machine (RMB), a deep belief network (DBN), a bidirectional recurrent deep neural network (BRDNN), deep Q-networks, or the like, but not limited to the above-mentioned example.

According to an exemplary embodiment of the present disclosure, the processor may implement artificial intelligence. The artificial intelligence refers to an artificial neural network-based machine learning method for simulating a biological neuron of a person such that a machine learns it. The methodology of artificial intelligence may be divided into supervised learning in which the answer (output data) to the problem (input data) is fixed as the input data and output as training data are provided together according to a learning scheme, unsupervised learning in which the answer (output data) to the problem (input data) is not fixed as only the input data is provided without the output data, and reinforcement learning for proceeding with learning in the direction of maximizing a reward, as the reward is given in an external environment whenever taking a certain action in the current state. Furthermore, the methodology of artificial intelligence may be divided according to architecture which is the structure of a learning model. The architecture of a widely used deep learning technique may be divided into a convolutional neural network (CNN), a recurrent neural network (RNN), a transformer, generative adversarial networks (GAN), and the like.

The present device and the system may include an artificial intelligence model. The artificial intelligence model may be one artificial intelligence model and may be implemented with a plurality of artificial intelligence models. The artificial intelligence model may be composed of a neural network (or an artificial neural network) and may include a statistical learning algorithm for imitating the nerves of biology in machine learning and cognitive science. A neural network may refer to the overall model with a problem solving ability, as an artificial neuron (a node) forming a network through the combination of synapses changes synaptic coupling strength through learning. The neurons of the neural network may include a combination of weight values or biases. The neural network may include one or more layers, each of which is composed of one or more neurons or nodes. Illustratively, the device may include an input layer, a hidden layer, and an output layer. The neural network constituting the device may change the weight values of the neurons through learning to infer a result (an output) to be predicted from any input.

The processor may generate a neural network, may train or learn the neural network, or may perform computation based on received input data, and may generate an information signal or may retrain the neural network based on the performed result. Models of the neural network may include, but are not limited to, various types of models, such as a convolution neural network (CNN), such as GoogleNet, AlexNet, or VGG Network, a region with convolution neural network (R-CNN), a region proposal network (RPN), a recurrent neural network (RNN), a stacking-based deep neural network (S-DNN), a state-space dynamic neural network (S-SDNN), a deconvolution network, a deep belief network (DBN), a restricted Boltzmann machine (RBM), a fully convolutional network, a long short-term memory (LSTM) network, and a classification network. The processor may include one or more processors for performing computation according to the models of the neural network. For example, the neural network may include a deep neural network.

Those skilled in the art will understand that the neural network may include any neural network which may include, but is not limited to, a convolutional neural network (CNN), a recurrent neural network (RNN), a perceptron, a multilayer perceptron, feed forward (FF), a radial basis network (RBF), deep feed forward (DFF), a long short term memory (LSTM), a gated recurrent unit (GRU), an auto encoder (AE), a variational auto encoder (VAE), a denoising auto encoder (DAE), a sparse auto encoder (SAE), a Markov chain (MC), a Hopfield network (HN), a Boltzmann machine (BM), a restricted Boltzmann machine (RBM), a deep belief network (DBN), a deep convolutional network (DCN), a deconvolutional network (DN), a deep convolutional inverse graphics network (DCIGN), a generative adversarial network (GAN), a liquid state machine (LSM), an extreme learning machine (ELM), an echo state network (ESN), a deep residual network (DRN), a differentiable neural computer (DNC), a neural turning machine (NTM), a capsule network (CN), a Kohonen network (KN), and an attention network (AN).

According to an exemplary embodiment of the present disclosure, the processor may use, but is not limited to, various artificial intelligence structure and algorithms, such as a convolution neural network (CNN), such as GoogleNet, AlexNet, or VGG Network, a region with convolution neural network (R-CNN), a region proposal network (RPN), a recurrent neural network (RNN), a stacking-based deep neural network (S-DNN), a state-space dynamic neural network (S-SDNN), a deconvolution network, a deep belief network (DBN), a restricted Boltzmann machine (RBM), a fully convolutional network, a long short-term memory (LSTM) network, a classification network, generative modeling, explainable AI, continual AI, representation learning, AI for material design, BERT for natural language processing, SP-BERT, MRC/QA, text analysis, a dialog system, GPT-3, GPT-4, visual analytics for vision processing, visual understanding, video synthesis, anomaly detection for ResNet data intelligence, prediction, time-series forecasting, optimization, recommendation, and data creation. Hereinafter, an embodiment of the present disclosure will be described in detail with reference to the accompanying drawings.

Hereinafter, a description will be given in detail of a method for generating subtitles and voice dubbing using the above-mentioned components.

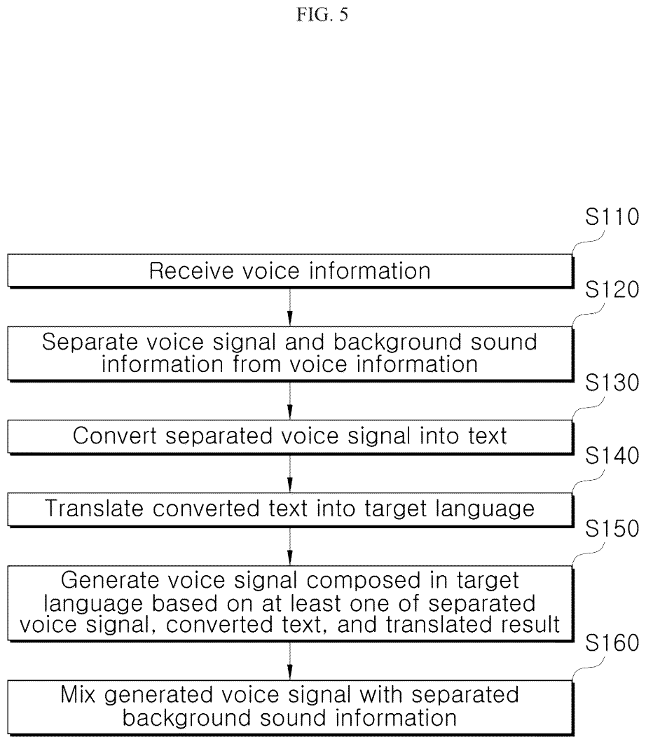

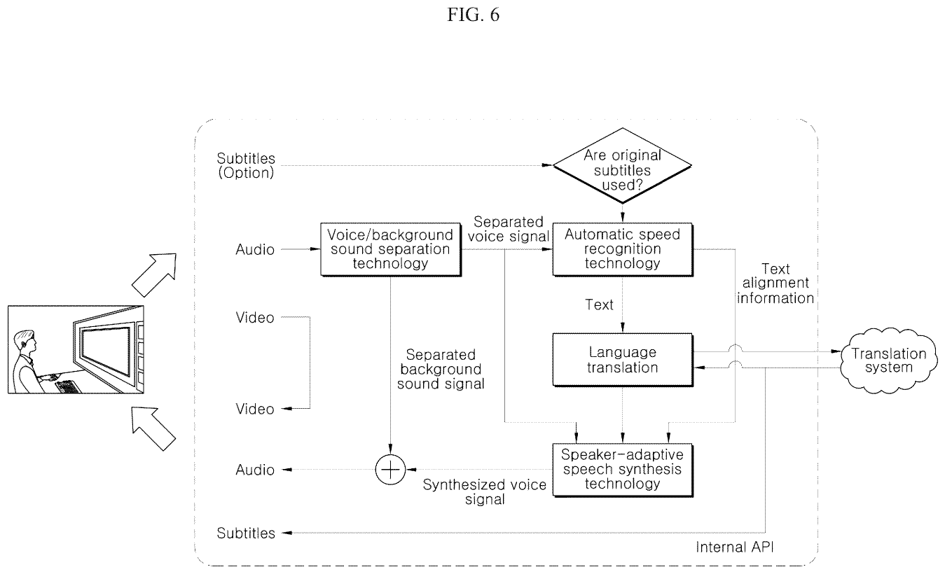

FIGS. 5 and 6 are flowcharts of a method for generating subtitles and voice dubbing according to the present disclosure.

Referring to FIGS. 5 and 6, a step of receiving voice information may proceed (S110). Herein, the step of receiving the voice information may be a step of receiving image information. A system for generating subtitles and voice dubbing may receive image information and may use voice information included in the image information to generate the subtitles and the voice dubbing. In contrast, the step of receiving the voice information may be a step of receiving the voice information itself rather than image information.

In the specification, the voice information may include all pieces of data associated with a sound included in an image. As an embodiment, the voice information may include a voice signal and a background sound included in the image information.

A processor may receive the image information and may process voice information included in the image information.

Next, a step of separating a voice signal and background sound information from the voice information may proceed (S120).

The processor may separate the voice signal and the background sound information from the voice information to generate a separate file.

The voice signal is a voice of a speaker, which is included in the image information, and is information which is a target for generating subtitles and voice dubbing. Subsequently, the voice signal separated from the voice information may be generated as at least one of the subtitles and the voice dubbing.

The separation of the voice signal and the background sound information may be performed via a separate artificial intelligence model trained to separate the voice signal and the background sound information from the voice signal.

Next, a step of converting the separated voice signal into text may proceed (S130).

The voice signal may be converted into text via a speech recognition module 310. Herein, the text may be configured in a language which is the basis of making the image from which the voice signal is separated.

In the specification, the language which is the basis of making the image is referred to as an “original language” and a language for generating subtitles and voice dubbing is referred to as a “target language”.

Next, a step of translating the text composed in the original language, which is converted, into the target language may proceed (S140).

The translated result may be in the form of text composed in the target language and may be provided as subtitles of the original image.

The type of the target language may be received from a video producer or a user who views a video.

In an embodiment, the video producer may specify the target language in advance and may generate subtitles for at least one target language from a video production stage.

In an embodiment, the video producer may specify a target language desired by a viewer who views a video to generate subtitles, without generating the subtitles. Subtitles made by a specific video viewer may be provided to a video viewer who requests subtitles in the target language again.

The translated result may be used to subsequently generate voice dubbing. A description will be given below of it.

Meanwhile, the translation may be performed via a separate artificial intelligence model trained to translate text composed in the original language into the target language. Herein, the type of the artificial intelligence model for translation is not separately limited.

Meanwhile, after generating the subtitles, the processor may synthesize the subtitles with the original image. At this time, the processor may set a time interval to insert the subtitles, with regard to a time interval when the voice signal is generated in the image information. In detail, the processor may match the time interval when the voice signal is generated in the image information in units of syllables, words, or sentences. After the voice signal is converted into the text, the time information matched in such a manner is matched with even the converted text. Thereafter, the time information may be matched with even the result of translating the converted text. The processor may insert the subtitles into the image information based on the image information.

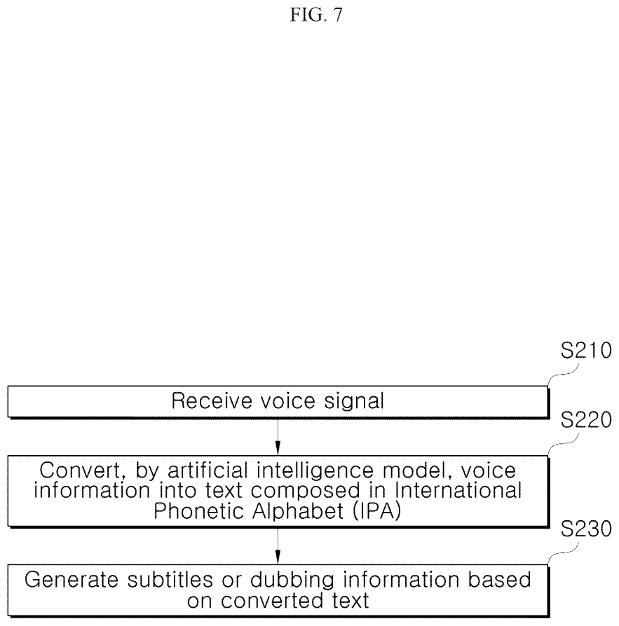

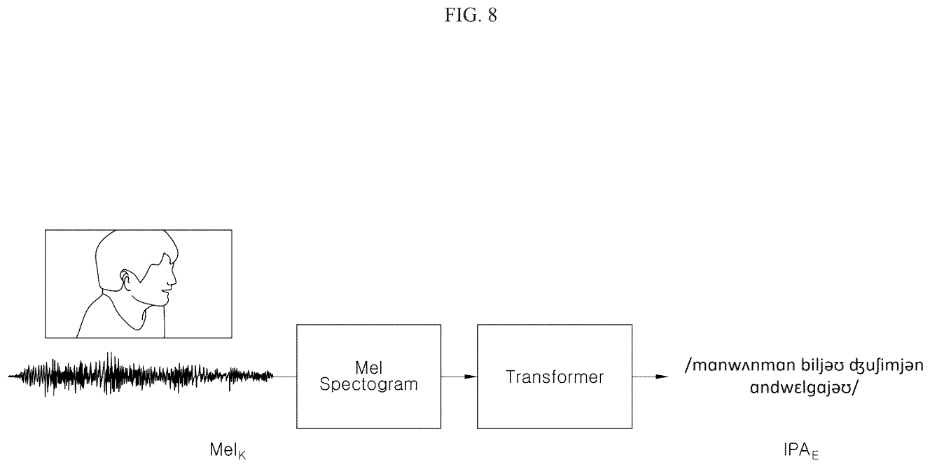

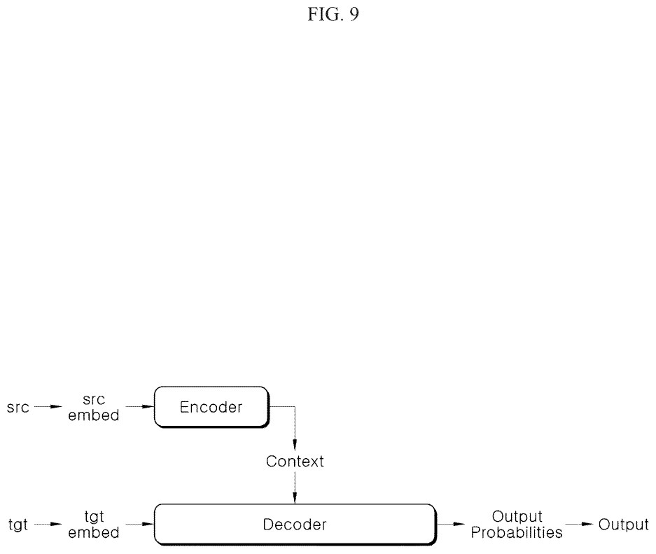

A step of generating a voice signal (hereinafter, dubbing information) composed in the target language based on at least one of the separated voice signal, the converted text, and the translated result may proceed (S150). FIG. 7 is a flowchart of a method for generating voice dubbing using the International Phonetic Alphabet according to the present disclosure. FIG. 8 is a conceptual diagram illustrating an embodiment of converting a voice signal into text composed in the International Phonetic Alphabet in a system for generating voice dubbing according to the present disclosure. FIG. 9 is a conceptual diagram illustrating an artificial intelligence model included in a system for generating voice dubbing according to the present disclosure.

Hereinafter, a description will be given in detail of a method for generating dubbing information composed of a target language with reference to FIGS. 7 to 9.

Referring to FIG. 7, a step of receiving a voice signal in an artificial intelligence module 320 may proceed (S210).

Herein, the information received by the artificial intelligence module 320 may be voice information included in image information or a voice signal in which background sound information is separated from the voice information.

The artificial intelligence module 320 may include an artificial intelligence module trained to convert voice information into the International Phonetic Alphabet (IPA).

Next, a step of converting voice information into text composed in the International Phonetic Alphabet (IPA) in the artificial intelligence model may proceed (S220).

In an embodiment, the artificial intelligence model may be, but is not limited to, a transformer.

In an embodiment, referring to FIG. 8, the artificial intelligence model may receive and convert voice information, “Could you lend me just 10,000 won?”, into the following International Phonetic Alphabet.

[symbol]

In an embodiment, referring to FIG. 9, the artificial intelligence model may be trained such that “src” is a voice signal composed in Korean, “tgt” is English IPA embedding, and “output” is English IPA embedding.

Thereafter, the artificial intelligence model may generate subtitles or dubbing information based on the converted text, that is, the text composed in the International Phonetic Alphabet (S230).

In detail, the artificial intelligence model may generate dubbing information about the voice information, based on the result of translating the converted text and the voice signal.

Herein, the translated result may be the translated result performed in S140.

The artificial intelligence model may convert the translated result into information composed in the International Phonetic Alphabet, based on the converted text. To this end, the artificial intelligence model may be trained to receive the result of translating the text composed in the International Phonetic Alphabet, which is generated based on the voice signal composed in the original language, and the voice signal composed in the original language and generate text which is composed in the International Phonetic Alphabet and is translated into a target language. In the training process, when using the International Phonetic Alphabet, the artificial intelligence model may generate dubbing information in which regional, social, cultural, and linguistic differences between the original language and the target language are reflected.

Furthermore, as described above, when using the International Phonetic Alphabet when training the artificial intelligence model to generate dubbing information, the artificial intelligence model may generate dubbing information for naturally pronouncing the target language.

Referring again to FIGS. 5 and 6, a step of mixing the generated voice signal (dubbing information) with the separated background sound information may proceed (S160).

The processor may generate subtitles on the image information, using the translated result generated in S140, and may mix the generated voice signal with the separated background sound information, using the result of generating the subtitles.

In detail, the processor may search for time information in which the subtitles are output on the image information and may mix the generated voice signal with the separated background sound information, using the found time information.

The processor may match a time interval when the voice signal is generated in the image information in units of syllables, words, or sentences. After the voice signal is converted into the text, the time information matched in such a manner is matched with even the converted text. Thereafter, the time information may be matched with even the result of translating the converted text. The processor may insert the subtitles into the image information based on the time information. Furthermore, the processor may use the above-mentioned time information to generate voice dubbing.

Meanwhile, the processor may mix the generated voice signal with the separated background sound information, using the result of separating the voice signal and the background sound information from the voice information included in the image information. In detail, the processor may mix the generated voice signal with the separated background sound information, using the time information in which the voice signal is separated from the voice information.

When separating the voice signal from the background sound information, the processor may match information defining the time interval when the voice signal is separated with the background sound information. Such time interval information may be defined in units of syllables, words, or sentences to be matched with the background sound information. The time information may be used when synthesizing the dubbing information with the background sound information.

As described above, according to the system for generating the subtitles and the voice dubbing according to the present disclosure, because the background sound separated from the voice information is synthesized after the voice dubbing is generated, the voice dubbing may be generated without the loss of a sound source.

Furthermore, according to the present disclosure, subtitles and voice dubbing may be generated at a faster speed than an existing method for manually generating subtitles and voice dubbing.

Furthermore, according to the present disclosure, subtitles and voice dubbing in which regional, social, cultural, and linguistic differences are reflected may be generated.

Meanwhile, the disclosed embodiments may be implemented in the form of a storage medium which stores instructions executable by a computer. The instruction may be stored in the form of a program code and may generate a program module to perform operations of the disclosed embodiments, when executed by the processor. The storage medium may be implemented as a computer-readable storage medium.

The computer-readable storage media may include all types of storage media which store instructions decoded by the computer. For example, there may be a read only memory (ROM), a random access memory (RAM), a magnetic tape, a magnetic disc, a flash memory, optical data storage, and the like.

According to the system for generating the subtitles and the voice dubbing, because the background sound separated from the voice information is synthesized after the voice dubbing is generated, the voice dubbing may be generated without the loss of the sound source.

Furthermore, according to the present disclosure, the subtitles and the voice dubbing may be generated at a faster speed than an existing method for manually generating subtitles and voice dubbing.

Furthermore, according to the present disclosure, the subtitles and the voice dubbing in which the regional, social, cultural, and linguistic differences are reflected may be generated.

As described above, the disclosed embodiments have been described with reference to the accompanying drawings. Those skilled in the art to which the present disclosure pertains will understand that the present disclosure may be embodied in forms different from the disclosed embodiments without changing the technical spirit or essential characteristics thereof. The disclosed embodiments are illustrative and should not be construed as limiting.

What is claimed is:

1. A system for generating subtitles and voice dubbing, the system comprising:
a server: and
a terminal,
wherein the server includes:
a communication unit configured to receive image information or voice information from the terminal; and
a processor configured to:
separate a voice signal and background sound information from voice information included in the image information or the received voice information;
convert the separated voice signal into text;
translate the converted text into a target language;
generate a voice signal composed in the target language based on at least one of the voice signal, the converted text, and the translated result; and
mix the generated voice signal with the separated background sound information.

2. The system of claim 1, wherein the processor is configured to:
generate subtitles on the image information, using the translated result; and
mix the generated voice signal with the separated background sound information, using the result of generating the subtitles.

3. The system of claim 2, wherein the processor is configured to:
search for time information in which the subtitles are output on the image information; and
mix the generated voice signal with the separated background sound information, using the found time information.

4. The system of claim 3, wherein the processor is configured to:
mix the generated voice signal with the separated background sound information, using the result of separating the voice signal and the background sound information from the voice information.

5. The system of claim 4, wherein the processor is configured to:
mix the generated voice signal with the separated background sound information, using time information in which the voice signal is separated from the voice information.

6. A method for generating subtitles and voice dubbing in a system including a server and a terminal, the method comprising:
receiving, by the server, image information or voice information;
separating, by the server, a voice signal and background sound information from voice information included in the image information or the received voice information;
converting, by the server, the separated voice signal into text;
translating, by the server, the converted text into a target language;
generating, by the server, a voice signal composed in the target language based on at least one of the voice signal, the converted text, and the translated result; and
mixing, by the server, the generated voice signal with the separated background sound information.

7. The method of claim 6, wherein the synthesizing of the generated voice signal and the separated background sound information includes:
generating subtitles on the image information, using the translated result; and
mixing the generated voice signal with the separated background sound information, using the result of generating the subtitles.

8. The method of claim 6, wherein the synthesizing of the generated voice signal and the separated background sound information includes:
mixing the generated voice signal with the separated background sound information, using time information in which the subtitles are output on the image information.

9. The method of claim 8, wherein the synthesizing of the generated voice signal and the separated background sound information includes:
mixing the generated voice signal with the separated background sound information, using the result of separating the voice signal and the background sound information from the voice information.

10. The method of claim 9, wherein the synthesizing of the generated voice signal and the separated background sound information includes:
mixing the generated voice signal with the separated background sound information, using time information in which the voice signal is separated from the voice information.
